(19) United States
(12) Patent Application Publication
(10) Pub. No.: US 2003/0236676 A1
(43) Pub. Date: Dec. 25, 2003

(54) Process for funding multi-unit real estate projects

(76) Inventor: Robert Lionel Graham, Friendswood, TX (US)

Correspondence Address: Robert Lionel Graham, 17201 Blackhawk Boulevard, #1201, Friendswood, TX, 77546, US

(21) Appl. No.: 10/175,213

(22) Filed: Jun. 20, 2002

(51) Int. Cl. G06F 17/60

(52) U.S. Cl. 705/1

(57) ABSTRACT

A process for funding construction or conversion of multi-unit real estate projects with proceeds from sales of individual units therein, each requiring a re-sale contract, includes the steps of Unit sales to such unit buyers priced low enough to entice quick sell-out by deferring Developer's profit; Funding of all project costs before construction start from such unit sales; and Requiring unit re-sale contracts from such unit buyers to give developer or re-seller the opportunity to profit from re-sales of those units to retail unit buyers. This eliminates the project construction lender, thus project foreclosure risk, thereby lowering development risk to one unit per unit buyer. Developers can more readily get 100% project funding, better provide unit financing and earlier closing to retail unit buyers, and thus build more projects not now fundable considering project construction lender restrictions.

### BACKGROUND OF THE INVENTION

The present invention relates generally to the field of real estate financing and more specifically to a process for funding the construction or conversion of multi-unit real estate projects, each with proceeds from sales of individual units therein at discount prices to entice quick funding by deferring the developer's profit, with each such unit sale at discount including a unit resale contract so that the developer might have the opportunity of profiting on the re-sales of those units.

Unit ownership in multi-unit real estate projects is as old as Rome. The word “condominium” is taken from Latin. As population increases, transportation and communication restraints require increased densities and thus the need for more multi-unit projects. As the cost of desirable amenities and good locations increase, sharing their costs in a multi-unit project gives the occupants more value than by each paying for them as single homeowners. All occupants want the advantages of owning real estate to have inflation build equity rather than increase their rent. These are the driving forces that have and will continue to increase the demand for unit ownership in multi-unit real estate projects and encourage their construction and conversion.

Common forms of multi-unit real estate Projects are residential apartments, townhouses and even single-story detached houses, office buildings and campuses of commercial, industrial and retail spaces, resort and time-share units, marina slips and even airplane hangers.

Common rights of multi-unit real estate ownership include any range of rights from fee-simple title to shorter-term leaseholds of either the entire bundle of rights or somewhat less, either in time or by including or excluding mineral rights, appurtenances, easements or access to amenities.

Ownership of multi-unit real estate Projects can be organized in many forms of association for ownership and management of their units or time therein and their common elements and areas. These forms include condominiums, time-shares, floating or fixed interval rights and cooperative stock ownership with Unit leases.

The investment advantages of Unit ownership in a multi-unit real estate Project include less risk because each Unit Owner individually owns 100% of his one individual Unit without risking his investment for the obligations or liabilities of the other Unit Owners beyond funding just his one Unit's maintenance and share of the common elements, more control because he can sell, lease or hold his individual Unit, rather than depending on the Developer if he had a minority share in a real estate syndication, and better borrowing power because each Unit Owner can get his own mortgage loan secured by just his one Unit to buy, improve or borrow against the equity in it.

Given the predictability of increasing real estate prices, tenants have come to recognize that owning their Unit is the best way to limit increases in their occupancy cost. Groups of tenants have organized and purchased their building from the landlord. As they have later re-sold their Units at a profit, Developers have come to see that there is a profit to be made in building or converting for sale of individual Units.

However, to get Project funding, Developers have had to convince Financial Partners and Construction Lenders. Of those Projects that have been built or converted, some have successfully sold-out, but others have not, creating foreclosure and unit-valuation problems that have made it harder for following Developers to obtain funding for further Projects. The result is that Project funding is virtually impossible in all but the largest markets and to all but the strongest Developers. The result of these restrictions on Project funding is that the cost of Units has increased to offset the risk, and no Projects are getting built if they are too small or too large or if they are in smaller markets or in lower-income or marginally outlying areas.

The risks of Project development avoided by the present invention are many and easily explained:

Partial Unit Sale Risk˜Because a Project takes years to develop, build and sell all the Units, prices, sales absorption rates and sales prices can change as can construction costs and mortgage interest rates. So, what gets planned to be quickly built and easily sold often does not. With slow unit sales, a Developer and his Financial Partners will default on the Project Construction Loan. The Construction Lender then will have to sell the remaining Units or sell the whole Project as a rental project. Construction Lenders have found that it is almost impossible to sell remaining units (usually the majority) because the early Unit Buyers are both unhappy and disruptive. Thus, to prevent foreclosure of a partially sold project, Construction Lenders prevent Unit sale from closings until most of the Units are pre-sold. This makes it harder for the Developer to sell Units, because he must convince each potential Unit buyer to wait until most of the Units are sold before any Unit Buyers can close and move-in.

Unit Value Dilemma˜Because Units might not quickly re-sell during the Developer's initial sales campaign and Unit mortgage lenders recognize the power of the Developer's marketing efforts to establish Unit prices that might not be sustainable, institutional Unit mortgage lenders will not lend to Unit buyers on conventional terms offered to other home buyers until after the Project's Units are substantially sold-out. This imposes a further risk to the Developer and Financial Partners to either subsidize such Unit mortgages or risk waiting until the substantial portion of the Units is pre-sold before closing any Unit sales. The development risks and costs are thus increased and must be reflected in higher Unit prices. More importantly, Projects don't get built if they are too small or too large or if they are in smaller markets or in lower-income or marginally outlying areas.

Conversion Decision Risks˜Most all multi-unit rental Project Owners have an institutional permanent mortgage loan on their Project. Such loans do not permit sale of individual Units. So, the Project Owner must incur the up-front costs of refinance to a more expensive Interim Loan in order to convert for Unit sales. Moreover, tenants who do not want to buy will leave when they hear that their Unit might be sold. Without some surety that all the Units will sell, many Project Owners do not convert and miss-out on the substantial profits that could be made from Unit sales. Also, many Project Owners cannot raise the funds for renovations without the additional value created by Unit sales, and those Projects deteriorate rather than get renovated and sold to individual Unit Buyers who would benefit from homeownership and take better care of the Project.

The present form of funding of construction or conversion of multi-unit real estate Projects with Unit ownership entails the following steps:

The Developer first gets control of the real estate and obtains permits to construct or convert it to a multi-unit Project with Unit ownership,

The Developer then gets a Construction Lender to provide a Construction Loan for most of the purchase, construction or conversion costs, if and when:

The Developer and its Financial Partners guarantee and/or provide additional collateral to secure timely payment of the Construction Loan, and/or

The Developer pre-sells most or all of the Units to further assure the Construction Lender of the Project's profitable and timely sell-out prospects, and

The Developer provides a competent builder, Unit sales and Project management team.

The Developer and its Financial Partners provide the equity for the remainder of the purchase, construction or conversion, marketing, financing, interest and operating costs through the projected Unit sell-out period,

Construction then starts and then completes, as Unit sales continue because some pre-sold Retail Unit Buyers get lost during the multi-year time between their Unit reservation and Unit delivery only after completion and satisfaction of the Lender's “pre-sale” requirement,

The Developer then has to replace Retail Unit Buyers to reach the Construction Lender's “pre-sale” requirement under threat of forecloses on the entire Project.

These multiplied risks are inherent in the present form of funding multi-unit Projects for Unit ownership. The risk of profitably selling enough Units in a multi-unit complex before the Construction Loan comes due is all concentrated in the Developer/Financial Partners entity. Because the risk is high in dollars, time and probability of success, Investors wealthy enough to take these risks are few, and the profit required to involve them increases Unit prices and limits the number of Projects that get built to just those in major and growing markets.

The Financial Partners' risk is substantial because their investment is committed at start of construction, and construction and sales can take 2 to 4 years. Everything can change in that time. In recent years, mortgage interest rates have fluctuated in a range from 6% to 16%, there has been an oil crisis, terrorism attacks, stock market fluctuations, a high-tech boom and bust, military base closures, 2+ wars, recessions, employment dislocations and tax law changes, all of which have effected Unit marketability, affordability and ability of potential Unit Buyers to finance their purchase.

Also, Construction Lender requirements restrict the number of Projects that can be built or converted because: Construction Lenders' cost of underwriting the risks is so expensive that only larger projects can afford such costs by spreading them among more and higher-valued Units; the expertise required to underwrite such Projects is so complicated that it is found only in larger Construction Lenders who must fund only larger projects to afford to compensate their higher priced staff, and there are fewer investors who have the high net-worth and the willingness to risk the larger amount required to guaranty an entire Project to the Construction Lender than there are smaller investors who are willing to take the risk on just one Unit.

These multiplied risks of Project financing by one Developer and its Financial Partners now require that Unit market values be more predictable, and that is possible only if there are many comparable Units already in the market. This combination of requirements is found only in major urban centers or resorts that are in their growth phase, so smaller, more stable, outlying and lower-income communities don't qualify and don't get multi-unit Projects built there.

With the present invention, Construction Lenders and Financial Partners are eliminated. They are replaced by Wholesale Unit Buyers. Because the Wholesale Unit Buyers get title to and pay for all Units at start of construction, there follows that: there can be no Project foreclosure, because there is no Project Lender; all funds for construction, marketing and operations through projected sell-out are funded at construction start from Wholesale Unit purchases; and Developer's investment is then only his time and potential profit.

With Project Conversion Loans, additionally the Developer must pay-off the whole present permanent mortgage loan on the entire Project with a new Conversion Loan because that existing Permanent Lender won't permit the sale of just one Unit. Permanent Lenders just do not have the staff or profit potential to justify administering the conversion process. The need to payoff the present permanent loan creates a major risk for the Project Owner of committing to a new Project Conversion Loan without knowing if enough Units will sell at projected Retail prices to at least break-even.

With the present invention, these risks would be avoided. Full funding from sales to Wholesale Unit Buyers would be available when needed and thus assure payment of all costs before having to pay-off the present permanent loan. The present invention has these advantages for the Developer:

The process of getting and keeping Financial Partners would be eliminated,

The process of getting a Construction Lender would be eliminated along with:

Retail Unit “pre-sale” requirement,

Project foreclosure threat,

Personal Guarantee and Pledge of other assets against risk of loss on sell-out.

The need to get and keep “pre-sale” Retail Unit Buyers to satisfy a Construction Lender would be eliminated,

Sales to Wholesale Unit Buyers would provide 100% cost funding at start of construction or conversion,

Developer's cost of funds would be Re-Sale Contract payments to Wholesale Unit Buyers.

Developer's profit would be earned on Retail Unit sales by assignment of Unit Re-Sale Contracts,

If funds from Wholesale Unit Buyers and Retail Unit sales do not provide enough to keep paying Unit Re-Sale Contract payments, the Developer would not be foreclosed on the entire Project, but only suffer Cancellation of Re-Sale Contracts on those Units on which it could not continue payments.

Thus, the Developer's risks would be only the loss of profits, once it has funded Wholesale Unit sales at start of construction or conversion.

Thus, the Developer has greater control of the Project development without a Construction Lender or Financial Partners.

The present invention has these advantages for the Real Estate Industry:

More projects would get built because Developers could more readily get 100% Project cost funding from a group of Wholesale Unit Buyers rather than from one Construction Lender,

More projects would get built in smaller markets, lower-income neighborhoods and in outlying areas where there are many potential Wholesale Unit Buyers willing to invest/buy one Unit at a price discounted to cost, but where present Construction Lenders and Financial Partners are not now economically available.

More projects would get built because the Wholesale Unit Buyers investment risk would be for only one Unit and thus less risky than the Construction Lender and the Financial Partners risk on the entire Project resulting in a lower return needed to entice him to invest.

Thus, the financial cost of producing Units would be less, perhaps reducing their prices and resulting in more Units being built in areas not now served.

The present invention has these advantages for the smaller Wholesale Unit Buyer as investor:

Greater control of his investment by buying 100% of a single Unit rather than a minority share in a Project syndication.

Unit ownership at start of construction or conversion eliminates the possibility of foreclosure if Developer defaults and stops making Re-Sale Contract payments. The Unit could then be rented or sold without delay to maintain income or recoup investment.

Unit ownership would not be exposed to the risks of other investors or Unit owners in the Project defaulting as would be the case in minority investment in a Project syndication.

Unit purchase at a discount because of the Developer would defer its profit. This should result in:

Minimizing risk of loss of investment on resale,

Ability to rent the Unit to provide a return on investment should the Developer default on Re-Sale Contract,

Completion Guaranty would insure against delay or default in completion of construction.

The present invention has these advantages for the Retail Unit Buyer:

Ability to close Unit purchase before now permitted by Construction Lender restrictions, and even during construction, whereas present Lender Restrictions requiring “pre-sale” would prevent early closing. This would permit early planning for decoration and furnishing without fear that Developer's failure to reach “pre-sale” would prevent closing.

Get Unit mortgage from the Wholesale Unit Buyer, until most Units are sold and conventional mortgage loans are thereafter available

### BRIEF SUMMARY OF THE INVENTION

The primary object of the invention is to transfer the risk of multi-unit real estate Project construction and conversion from one Developer and its Financial Partners taking the risk on all Units in a Project to a Project funding structure in which many individual Unit Buyers each take the risk on only one Unit each so as to:

Increase availability of funding for construction or conversion of multi-unit real estate Projects,

Lower the cost of Units in multi-unit real estate Projects or increase the Developers' profits,

Increase feasibility of building Projects in smaller markets, lower-income areas and outlying locations;

Provide smaller investors with real estate investments over which they can have more control and which have lesser risks, and

Provide Retail Unit Buyers with availability of earlier closing dates and interim Unit financing.

### OBJECTS OF THE INVENTION

The object of the invention is to more readily provide Developers with 100% of Project construction or conversion funds and marketing and financial costs, all from Wholesale Unit Sales by offering them each at a lower price by the Developer deferring its profit until Retail Unit Sales close.

Another object of the invention is to expand the availability and lower the cost of such Project funding by eliminating the Developer's need for a Project Construction Lender who delays Retail Unit sale closings thereby eliminating the overall Project sell-out risk of Project foreclosure, replacing the funding source with proceeds from Wholesale Unit Buyers who need risk the much smaller investment of the price of an individual Unit, thereby reducing the return required to attract capital for funding Project construction or conversion.

Another object of the invention is to eliminate the need for Financial Partners who have to make a large financial equity investment and perhaps guaranty and/or pledge additional assets to secure the Construction Lender against Project sell-out risks by replacing the Construction Lender with proceeds from Unit sales to Wholesale Unit Buyers.

Yet another object of the invention is to give the Developer more control over its Project design and potential for profit by replacing funding source of Financial Partners and one Project Construction Lender with many Wholesale Unit Buyers.

Another object of the invention is to enable the Developer to have the option to be taxed at Capital Gains tax rates on sale of its Project rather than at Ordinary Income tax rates on sale of the Units.

Another object of the invention is to give the Developer the option to be insulated from construction-defect liability to Unit Owners by structuring the Project development process so that the Unit Owners' Association does the construction or conversion.

Yet another object of the invention is to avoid the legal, control and securities reporting requirements, delays and costs of syndication, replacing them with the more familiar rules of real estate sales and Unit owners' association structures.

A further object of the invention is to give the Developer more readily available Project funding by sale of individual Units to Wholesale Unit Buyers, because it should be easier to sell the individual Units than to borrow the entire Project's cost from a Construction Lender and find Financial Partners to guaranty that Project Loan.

Still yet another object of the invention is to give the Wholesale Unit Buyer a more conservative real estate investment because risks of loss on sale or rental would be substantially lowered by buying at a discount, and by eliminating delays of foreclosure or inability to act independently as in a syndication structure where each would be a minority Financial Partner of a Developer.

A further object of the invention is to provide Wholesale Unit Buyers a real estate investment that each can own without partners, thus giving each more control of that investment, without having to share the risk of Project failure or be a minority owner under the control of a syndicating Developer.

Still yet another object of the invention is to give the Wholesale Unit Buyers ownership at the start, so they each will have the ability to immediately rent or sell their individual Unit if the Developer or Re-Seller defaults on its Re-Sale Contract payments, with no delay of foreclosure since each would already have title to the Unit.

A further object of the invention is to give the Unit Buyers each the option to have a Unit Completion Guaranty to replace a portion of the Re-Sale Contract payments or provide a return on the price each paid until delivery of the completed Unit that each can then rent, sell or use.

Another object of the invention is to give the Unit Buyers each separation from construction decisions so that they each would not be subject to Unit Completion Guarantor's defenses, to better insure that they each get timely guaranty payments.

A further object of the invention is to give the Wholesale Unit Buyers the option to offer interim loans to Retail Unit Buyers of their Unit until conventional Unit mortgage loans are available, thus giving the Wholesale Unit Buyer an option to extend his investment time and increasing the likelihood and the price at which such Retail Unit Buyers would buy.

Another object of the invention is to give Retail Unit Buyers each the availability of financing for purchase of a Unit from the Wholesale Unit Buyer of that Unit before the substantial number of Units are sold to Retail Buyers, as is otherwise presently a restriction imposed by Project Construction Lenders fearing the possibility of having to foreclose on a partially sold-out Project.

A further object of the invention is to give Retail Unit Buyers each perhaps a lower price if the potentially lower financial costs of the present invention are passed-on rather than used to increase the Developer's profit.

Yet another object of the invention is to encourage more construction and conversions of multi-unit real estate Projects that are otherwise unfinancable by present Project Construction Lenders and Financial Partners because such proposed Projects:

Are in smaller, lower-income, unstable or outlying markets,

Have unusual or untested design or location,

Have too few Units or too many Units to justify the underwriting costs of a Construction Lender.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a flow chart of the Project Funding Process in accordance with a preferred embodiment of the present invention showing the steps, wherein the nine 9 types of Parties enter into eight (8) types of Agreements and execute-fourteen 14 types of Steps to accomplish eight 8 types of Events to accomplish Project funding; these Parties, Agreements, Events and Steps are all illustrated on FIG. 1 attached to this patent application and are enumerated as follows:

| PARTIES: | | AGREEMENTS: | |
|---|---|---|---|
| P1 | Developer | A1 | Funding Plan Agreement |
| P2 | Plan Administrator | A2 | Wholesale Unit Sale |
| | | | Contracts(s) |
| P3 | MarketinglSales Team | A3 | Retail Unit Sales Contract(s) |
| P4a | Wholesale Unit Buyer(s) | A4 | Unit Mortgage Loan(s) |
| P4b | Retail Unit Buyer(s) | A5 | Unit Completion Guaranty(s) |
| P5 | Unit Completion Guarantor(s) | A6 | Unit Re-Sale Contract(s) |
| P6 | Unit Mortgage Lender(s) | A7 | Fund Control Agreement(s) |
| P7 | Owners' Association | A8 | Interim Loan(s) |
| P8 | Building Team | | |
| P9 | Unit Re-Seller(s) | | |

EVENTS:

| | |
|---|---|
| E1 | Closing of all Unit Sales |
| E2 | Construction Start |
| E3 | Construction Completion |
| E4 | Retail Unit Sale Closing(s) |
| E5 | Cancellation(s) of A6s |

STEPS:

| | | | |
|---|---|---|---|
| S1 | Define Project Funding | S6 | Fund Purchase Prices of |
| | Process | | A2s & A3s |
| S2a | Deliver Project, ready | S7a | Grant Construction |
| | to build | | Responsibility |
| S2b | Pay Land Debt and | S7b | Deliver Funds for Fund |
| | Reimburse P1 | | Control |
| S2c | Administer A1 | S8 | Deliver Construction |
| | | | Documents |
| S2d | Administer Marketing & | S9a | Fund Control Construction |
| | Sales | | |
| S3a | Sell Units to Wholesale Unit | S9b | Direct Project Construction |
| | Buyers | | |
| S3b | Self Units to Retail Unit | S10 | Construction or Conversion |
| | Buyers | | |
| S4a | Grant A4s | S11a | Deliver A6s to P9s |
| S4b | Monthly Unit Mortgage Loan | S11b | Re-Sell Units to P4bs |
| | Payments | | |
| S5a | Grant A5s | S12 | Monthly Re-Sale Contract |
| | | | Payments |
| S5b | Grant Lender's Rights in A5s | S13 | Grant Interim Loans |
| S5aD | Make monthly payments | S14a | Deliver Unit, Profit, Interim |
| | from E5 to E3 | | Loan pay-offs |
| S5bD | Make monthly payments | S14b | Distribute Profits on Retail |
| | from E5 to E3 | | Unit Re-Sales. |

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting the scope of the invention to the particular form set forth, but rather, it is intended as a basis for the claims so as to include such alternatives, modifications and equivalents as may be included within the spirit and scope of the invention, and as a representative basis for teaching one skilled in the art to employ the present invention in virtually any appropriately detailed process, method, system, structure or manner.

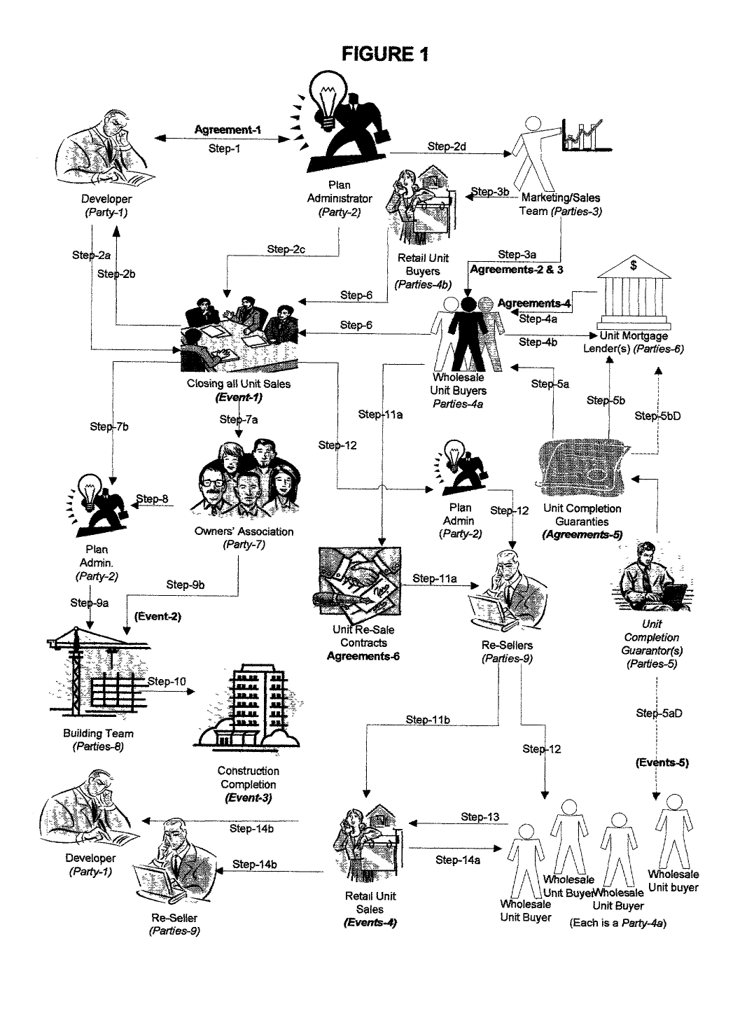

In accordance with a preferred embodiment of the invention, there is disclosed on FIG. 1 a process for funding the construction or conversion of multi-unit real estate Projects, especially residential condominium complexes, each with proceeds from its Unit sates at discount prices Sa, with each such Unit sale requiring a Unit Re-Sale Contract A6 so that the Developer P1 or Re-Sellers P9s might have the opportunity to realize profits on such Re-Sales E4 of those Units to Retail Unit Buyers P4bs.

To accomplish the functions of the invention, FIG. 1 shows how the present invention process proceeds, comprising four 4 phases:

Phase 1˜Plan Agreement: In accordance with the primary function of the invention, in its preferred embodiment, the Developer P1 would have a Project ready to build S2a, usually with permits, plans and studies approved, Unit prices scheduled, construction costs confirmed, values and absorption rates appraised, marketing/sales planned and team members agreed. The Plan Administrator P2 would define the Project Funding Plan A1 with the Developer P1, get Unit Completion Guaranties A5s from Unit Completion Guarantors P5s and Unit Loans A4s from Unit Mortgage Lenders P6s. Then, the Developer P1 and Plan Administrator P2 would enter into a Project Funding Plan Agreement A1.

Phase-2˜Unit Sales: Turning again to FIG. 1, the preferred embodiment of the invention process provides that the Marketing/sales Team P3s would then market S3a Units directed by the Developer P1 and administered S2d by the Plan Administrator P2 to get Sale Contracts A2s for all Units in the Project from Wholesale Unit Buyers P4as and perhaps also sell Units S3b to get Sale Contracts A3s from Retail Unit Buyers P4bs. To encourage sales to Wholesale Unit Buyers P4as, the Units would be priced at a discount and low enough in order to entice a quick sell-out. The major part of the discount offered would be accomplished by deferring the Developer's profit S14b.

Phase-3˜Construction or Conversion; Turning again to FIG. 1, the preferred embodiment of the invention process also provides that when all Units have been sold S3, all funds required for Project Construction S10, land, marketing and Unit Re-Sale Contract Payments S12 through projected sell-out period would be funded S6 and there would be a Closing E1 of all Unit sales wherein:

The Unit Buyers P4as & P4bs would form an Owners Association P7 and vote to adopt and proceed with the invention Project Funding Plan Agreement A1,

The Developer P1 would sell the Project S2a to the Owner's Association P7 or to a separate party,

The Unit Mortgage Lenders P6s would grant S4as Unit Mortgage Loans A4 to the Unit Buyers P4as & P4bs,

The Unit Completion Guarantors P5s would issue Unit Completion Guaranties A5s to Unit Buyers P4as & P4bs S5a and to their Unit Mortgage Lenders P6s S5b,

The Wholesale Unit Buyers P4as would grant and deliver S11a Unit Re-Sale Contracts A6 to the Developer P1 or to Re-Sellers P9s. Exclusive right-to-sell listing agency contracts could replace Re-Sale Contracts A6s to provide Developer P1 and/or Re-Sellers P9s the opportunity to profit on Re-Sales S14b.

The Unit Buyers P4as & P4bs could close, transfer title, etc. E1 on their purchases of all Units and pay for their respective purchase prices S6,

The Owner's Association P7, or separate party, would take the Unit sale proceeds and responsibility for building the Project S7a, perhaps augmented with funds from the Developer's P1 other sources, and deposit them S7b to be Fund Controlled S9a by the Plan Administrator P2 pursuant to a Fund Control Agreement A7,

The Owner's Association P7 would deliver and activate construction contracts S8 with the Building Team P8,

Start Construction or Conversion E2 and direct Project Construction S9b,

The Building Team P8 would then complete Construction or Conversion S10.

From initial Closing E1, the Re-Sellers P9s could close Unit Re-Sales S11bs to Retail Unit Buyers P4bs, so long as the Re-Seller made monthly Re-Sale Contract Payments S12 on the Unit Re-Sale Contract A6 on that Unit,

Phase4˜Re-Sales to Retail Unit Buyers: Turning again to FIG. 1, the preferred embodiment of the invention process provides further that at any time in the process after initial Closing E1, Units are available for Re-Sale S11b to Retail Unit Buyers P4bs, so that:

At each Retail Sale Closing E4, the Wholesale Unit Buyer P4a of that Unit would be re-paid his price, including the profit negotiated in his Re-Sale Contract A6, and

Funds would be provided at initial Closing E1 for such monthly Unit Re-Sale Contract Payments S12s as well as for marketing costs into Fund Control S12 and would be administered by the Plan Administrator P2.

If, however, the Re-Seller P9 stops making monthly Unit Re-Sale Contract Payments S12, the Wholesale Unit Buyer P4a of that Unit could cancel E5 the Unit Re-Sale Contract A6 and thereupon be free to rent, sell or use that Unit free of further rights of the Developer P1 or Re-Seller P9.

Unit Completion Guaranties:˜To accomplish an important function of the invention, there is shown also on FIG. 1 that the invention process provides for Unit Completion Guaranties E5s directly to Unit Buyers P4as & P4bs to insure them against losses due to construction delays, defaults and/or cost overruns, comprising the steps

Structuring the Building Team's P8 Project's construction or conversion S10 decisions and activities S7a to be made S9b by the Owners' Association P7 or by a separate party being granted construction responsibility S7a so that Unit Buyers P4as & P4bs are not subject to defenses on Unit Completion Guaranties E5s,

Unit sales S3as & S3bs to Unit Buyers P4as & P4bs with closing E1 and payment therefore before Construction or Conversion Start E2, and

Issuance of Unit Completion Guaranties Ass to Unit Buyers P4as & P4bs at that closing E1.

Should Construction S10 be delayed, each Completion Guarantor P5 would make all or part of the Unit Re-Sale Contract Payments S12 to that Wholesale Unit Buyer P4a and to the Unit Mortgage Lender P6 for that Unit, as agreed in the Unit Completion Guaranty A5 for that Unit until Construction Completion E3, at which time rental or resale by the Wholesale Unit Buyer P4a could then carry or recoup his investment.

Interim Loans to Retail Unit Buyers:˜To accomplish another important function of the invention, there is shown also on FIG. 1 that the invention process provides for Interim Loans A8s to Retail Unit Buyers P4bs, comprising the steps of:

Unit sales S11b to Retail Unit Buyers P4bs, each pursuant to a Unit Re-Sale Contract A6 by the Developer P1 or Re-Seller P9,

The ability of Retail Unit Buyers P4bs to close their Unit purchases before completion E3 and sell-out of most of the Project's Units as is otherwise required by Construction Lenders in existing Project funding processes,

The availability of an Interim Loan A8 from the Wholesale Unit Buyer P4a of each Unit to provide Unit financing until the Retail Unit Buyer P4b of that Unit can obtain a Conventional Permanent Mortgage Loan, which in existing Project funding processes are available only after the Construction Lender gives a partial release of its lien, which usually requires more than 50% of the Units to have been pre-sold and then delayed until they can all be closed simultaneously after Construction Completion E3.

Such Interim Loans S13 would be paid-off when the Retail Unit Buyer P4b refinances or sells that Unit S14a.

Turning again to the FIG. 1 flow chart of the present invention, the following items show what is old and already known in existing Project funding processes with Construction Loans and Financial Partners, and what is new in the present invention:

What is old and already known is that a Developer P1 with a Project ready-to-build S2a is required to start the Project funding process,

What is old and already known is that in existing Project funding processes there are requirements of underwriting Project feasibility S1, appraising prospective Unit sales prices, profit potential, costs and quality of the Development Team.

What is new in the present invention is that the underwriting S1 is not done by a Project Construction Lender because there is none, but rather by a Plan Administrator P2 which would then administer S2c the Project funding process.

What is also new in the present invention is that Unit sales S3s to Wholesale Unit Buyers P4as, and perhaps to Retail Unit Buyers P4bs are all closed E1, and paid for before Construction Start E2 and thus provide 100% of Project costs, including construction, marketing and financial carrying costs, and payoff land debt and perhaps reimburse Developer's costs S2b. This eliminates the risk of Project foreclosure by a Project Construction Lender due to slow Unit sales absorption, because in the present invention, the need for a Project Construction Lender is eliminated as is the need for Financial Partners to provide equity to guaranty the Project Construction Lender against failure of Unit sales.

What is old and already know is that in existing Project funding processes, there are Fund Control Agreements A7s and procedure to administer Construction or Conversion S10 expenditures appropriate to better provide for Construction Completion E3 on time and at budget.

What is old and already known is that in existing Project funding processes, marketing and sales to Retail Unit Buyers S3bs are required.

What is new in the present invention is that there is no Construction Lender, so Retail Unit Buyers P4bs can each independently close E4s their individual Unit purchases:

Without waiting for release from a Project lien and a pre-sale requirement to be met as is required by Project Construction Lenders in existing Project funding processes, and

Without threat of Project foreclosure by a Project Construction Lender because of a default by any other Unit Buyer or Developer P1, thus enabling Retail Unit Buyers P4bs to better plan their finances and occupancy moves.

What is also new in the present invention is marketing and sales S3as to Wholesale Unit Buyers P4as at a discount tow enough to entice quick sell-out by deferring Developers profit S14b, each combined with delivery S11a of Unit Re-Sale Contracts A6s so the Developer P1 or Re-Sellers P9s might realize profits S14b on Re-Sales E4s.

What is also new in the present invention is funding of all Project costs from such sales to Wholesale Unit Buyers P4as, and perhaps also to Retail Unit Buyers P4bs, with all Unit Buyers paying for their Units before Construction Start E2.

What is most importantly new in the present invention is including Unit Re-Sale Contracts A6s from Wholesale Unit Buyers P4as to give the Developer P1 or Re-Sellers P9s, the opportunity to profit from Re-Sales S11b to Retail Unit Buyers P4bs.

What is old and already known is that Unit Completion Guaranties A5s to Unit Retail Buyers P4bs who pay their purchase price up-front are required to insure them against losses due to construction delays, defaults and/or cost overruns in some jurisdictions in order to permit the Developer P1 to use such payments for Construction or Conversion S10. But in existing Project funding processes, Retail Unit Buyers' P4bs titles or contract rights to their Units are each subject to the lien of a Project Construction Lender who would have a common lien on all Units. This exposes each Retail Unit Buyer P4bs to a foreclosure risk because of default of the Developer P1 on the Project Construction Loan before Construction Completion E3. Although that Retail Unit Buyer P4b would get the price back, the Unit's titles could not be given to that Retail Unit Buyer P4b free of such Project foreclosure risk, so he could not plan to move-in because he would not know that he would get his Unit. The resulting requirement is that Retail Unit Buyers' P4bs funds must be kept in escrow or the Developer P1 must provide a cash bond, further increasing the cost of Project development.

What is new in the present invention is that the Unit Buyers' P4as & P4bs titles or contract rights are not subject to Project foreclosure risk and are free of Project Construction Lender's pre-sale restrictions because there is no Project Construction Lender.

What is also new in the present invention is that Completion Guaranties A5s are granted S5a also to Wholesale and Retail Unit Buyers P4as & P4bs and granted S5b also to their Unit Mortgage Lenders P6s.

What is also new in the present invention is that the Retail Unit Buyer P4bs can thus buy a Unit before Construction Start E2, close before Construction Completion E3 and plan to move-in on Construction Completion E3, without the risk that the Developer's P1 default might force a change in his moving plans. And if Construction Completion E3 is delayed, the Unit Completion Guarantor P5 will compensate him S5aD and pay all or part of his Unit Mortgage Loan A4 payments S5bD until his Unit is completed and delivered to him.

What is old and already known is that a Developer P1 could sell a Project S2a, ready-to-build, to an Owners' Association P7, or another, and its profit would be taxed at capital gains tax rates.

What is new in the present invention is that Re-Sellers P9s can, by getting Unit Re-Sale Contracts A6s get a separate opportunity for income on the same Project upon Re-Sales S11b of those same Units to Retail Unit Buyers P4bs, thus enabling the Developer P1 group to better segregate the profits derived from property appreciation from those profits attributable to the work of development and sales to most efficiently limit their taxes on profits.

What is also new in the present invention is that by selling the Project before Construction Start E2, the Developer P1 could be more insulated from construction-defect liability suits by the Owners' Association P7 or a separate party directing the Building Team P8 and/or the Project operator.

What is old and already known is that in existing Project funding processes, no Unit Mortgage Loans A4s can be secured by an individual Unit until the Project Construction Lender agrees to a partial release of that Unit. Thus, a group of Unit Buyers could not get individual loans secured by just their Unit to finance Project Construction or Conversion. Each Unit Buyer would have to join with others to get a Project Construction Loan. Such combinations would require a Developer and usually take the form of a syndication limited partnership or limited liability company to insulate each Unit Buyer from the liabilities on the entire Project. The resulting loss of control virtually eliminates the Unit Buyers from being the investors, thus giving rise to the need for Financial Partners and adding another level of profit and complication to the development process.

What is new in the present invention is that each Unit Buyer P4as & P4bs can purchase, pay for S6 and get title to E1 just one unit before Construction Start E2, and thus get S4 a Unit Mortgage Loan A4 from a Unit Mortgage Lender P6 secured by just his Unit, without partners or the loss of control associated with being a minority equity owner in a development syndication,

What is new in the present invention is that the Closing of all Unit Sales E1 before Construction Start E2 funds Project costs provides funds for Re-Sale Contract Payments S12s to each Unit Buyer, so that each Unit Buyer can make monthly Unit Mortgage Loan Payments S4bs and/or get a return on the Unit purchase price until their Unit is either resold S11b pursuant to its Re-Sale Contract A6 or free to his use, rental or re-sale.

What is also old and already known is that in existing Project funding processes, no Interim Loans can be secured by an individual Unit until the Project Construction Lender agrees to a partial release of that Unit. Interim Unit Loans A8s are thus delayed until the Project Construction Lender's “Pre-Sale” requirement is met and Construction Completion E3 before it permits any partial releases of Units. These requirements delay closing of sales to Retail Unit Buyers P4bs, increase the Developer's P1 risk of loosing pre-sales because of the long time-delay, and require that the Developer P1 to get Financial Partners to further guaranty the Project Construction Lender in order to shorten that delay. All this delay increases Project risks and costs and thus prevents Projects construction or conversion in all but the most large, established and growing areas.

What is new in the present invention is that each Wholesale Unit Buyer P4a would already have received clear title to each individual Unit by buying it E1 before Construction Start E2, thus any Wholesale Unit Buyer P4a could transfer title during construction to a Retail Unit Buyer P4b, free from any Project Construction Lender's lien on all Units, because there would be no Project Construction Lender.

What is also new in the present invention is that Wholesale Unit Buyers P4as replace the need for Financial Partners, because there is no need for the Developer P1 to provide equity and guaranties to a Project Construction Lender, because there is none. All Project funding is provided, up-front, by Unit sales S3s in the present invention.

What is also new in the present invention is that the Wholesale Unit Buyers P4as would have already paid for their respective Units either with their cash or with funds borrowed from Unit Mortgage Lenders P4s. Thus, all Wholesale Unit Buyers P4as would already have funds invested in their Units available to provide an Interim Loan A8 to the Retail Unit Buyer P4b of their Unit, either by:

Seller financing from personal funds, or

Assumption of the Unit Mortgage Loan A4 from the Unit Mortgage Lender P6 by the Retail Unit Buyer P4b of that Unit, thus making such Interim Loans A8s far more available and earlier in the Construction and Unit Sales process, even well before Construction Completion E3, and at a lower cost.

What is also new in the present invention is that Unit Mortgage Lenders P6s could get a good first lien on an individual Unit free of foreclosure threat by a Project Construction Lender, even before Construction Completion E3 and without waiting for a pre-sale requirement to be met, because there would be no Project Construction Lender in the present invention Project funding process.

What is old and already known is that in existing Project funding processes, is that a smaller real estate investor's ability to invest in a multi-unit real estate Project is limited to either investment in a very small project or as a minority investor in a syndication.

What is new in the present invention is that an individual small investor can purchase a single Unit in a multi-unit real estate project prior to its construction, and thus improve his investment position by having ownership of a Unit of real estate without any partners rather than owning a minority interest in a syndication partnership or limited liability company, thus giving the smaller real estate investor:

More control over the investment,

More liquidity, and

Less legal process and delay should there be a default on the Unit Re-Sale Contract A6.

What is also new in the present invention is its structure that enables a group of Wholesale Unit Buyers P4as to combine with a Developer P1 to build or convert more Projects and Projects in locations that are otherwise too small or too large or in smaller markets or in lower-income or marginally outlying areas where existing Construction Lenders and Financial Partners find it too risky or cannot profitably underwrite and provide Project funding. Such groups of smaller real estate investors would each have smaller risks, smaller invested amounts, greater control and more liquidity in their investments, thus enabling them to more readily provide Project funding.

Most significantly, what is new is that by using the present invention, a Developer P1 in any small community could get funding to build a 10 or so Unit Project by selling the Units at discount to local business people. With appraisals of the Units' sale-value to show the profit potential and appraisals of their rental-value to cover the Wholesale Unit Buyers' P4as down-side risk, and by noting that their risk would be in buying just one Unit per buyer with a Completion Guaranty A5, and by providing a Unit Mortgage Loan A4 to each Unit Buyer P4as, a Developer P1 could get Project funding committed with perhaps one presentation at a local business club luncheon. This could result in more condominium Units getting built, quicker and with lower financial risk, cost and delay; and building housing quicker and at lower financial cost is better for everyone.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. A process for funding the construction or conversion of multi-unit real estate Projects, each with proceeds from sales of individual Units therein to Wholesale Unit Buyers at discount prices, including Unit Re-Sale Contracts with each such Unit sale so the Developer might realize profits on Unit Re-Sales, comprising the steps of:
Funding of all Project costs before construction or conversion start from sales of Units therein priced at discount, and
Including Unit Re-Sale Contracts from each Wholesale Unit Buyer to give the Developer, opportunity to profit from Re-Sales of those Units to Retail Unit Buyers.

2. A process as claimed in claim 1 further comprising the steps of:
Structuring the multi-unit Project's construction or conversion decisions and activities so that Unit Buyers are not subject to defenses on Unit Completion Guaranties,
Selling to Unit Buyers with closing and payment therefore before construction or conversion start,
Issuing Unit Completion Guaranties to Unit Buyers and their individual Unit Mortgage Lenders at Unit sales closing.

3. A process as claimed in claim 1 further comprising the steps of
Selling Units to Retail Unit Buyers each pursuant to Re-Sale Contracts by the Developer, as Re-Sellers,
Closing sales to Retail Unit Buyers before Project completion or sell-out of most of the Project's Units, free of Project Construction Lender restrictions, and
Allowing Interim Loans from Wholesale Unit Buyers to provide Unit financing until Retail Unit Buyers can obtain a Conventional Unit Mortgage Loans.
